(19) United States
(12) Patent Application Publication
(10) Pub. No.: US 2009/0235827 A1
(43) Pub. Date: Sep. 24, 2009

(54) HOLDER AND CUP WITH CONCENTRATE FOR PREPARATION OF HOT BEVERAGES

(75) Inventors: Cornelis Margaretha Theodorus Maria Bongers, Helmond (NL); Wiebe Nicolaas van Druten, Zeewolde (NL)

Correspondence Address: SUGHRUE MION, PLLC, 2100 PENNSYLVANIA AVENUE, N.W., SUITE 800, WASHINGTON, DC, 20037, US

(73) Assignee: FRIESLAND BRANDS B.V., Meppel (NL)

(21) Appl. No.: 11/917,872

(22) PCT Filed: Jun. 22, 2006
(86) PCT No.: PCT/NL06/50144

§ 371 Date: May 8, 2008

(30) Foreign Application Priority Data
Jun. 22, 2005 (NL) 1029312
Mar. 14, 2006 (NL) 1031366

(51) Int. Cl. A47J 31/00; B65D 8/00

(52) U.S. Cl. 99/316; 220/669

(57) ABSTRACT

Cup for preparing a beverage by means of an appropriate holder (30) which is suitable for use in a hot water appliance. The cup (10) comprises a cup-shaped dish element (11) for holding a preparation substance, said cup-shaped dish element having an inlet aperture and an outlet aperture (24). The cup-shaped dish element (11) is provided on an open side with a covering layer (16), so that an interior space (25) of the cup (10) is formed for holding the preparation substance. The covering layer (16) is provided with liquid-permeable perforations and substantially the greater part of the surface of the covering layer (16) serves as the inlet aperture for receiving a liquid suitable for the preparation substance.

### FIELD OF THE INVENTION

The present invention relates to a cup for preparing a beverage by means of a hot water appliance, comprising a cup-shaped dish element for holding a preparation substance, said cup-shaped dish element having an inlet aperture and an outlet aperture, the cup-shaped dish element on an open side being provided with a covering layer, so that an interior space of the cup is formed for holding the preparation substance.

### STATE OF THE ART

Cartridges for use in the preparation of hot beverages based on a liquid concentrate are disclosed in, inter alia, WO-A-01/58786, EP-A-0 449 533, EP-A-1 101 430, WO-A1-03/073896, WO-A1-03/053200, WO-A1-02/19875, U.S. Pat. No. 6,130,990, U.S. Pat. No. 4,886,674, EP-A-1 440 907 and EP-A-1 440 908.

WO-A-01/58786 and EP-A-0 449 533 disclose a cartridge in which (hot) water is conveyed by way of a point shaped inflow aperture on the underside of the cartridge, by way of a ‘ring line’ containing distribution apertures, and further by way of said distribution apertures through a compartment containing a concentrate, the water diluting the concentrate by means of turbulence to form a beverage, which beverage is subsequently conveyed by way of a siphon to an outflow aperture on the underside of the cartridge.

EP-A-1 101 430 discloses a stepped cartridge in which, inter alia, facilities are accommodated for using a liquid concentrate (paragraphs [0034] and [0035]. For use of this cartridge the wall of the cartridge is pierced, after which (hot) water is conveyed through the concentrate by way of the inflow aperture(s) thus created and the concentrate thereby diluted to a beverage, said beverage leaving the cartridge by way of a likewise pierced outflow aperture.

WO-A1-03/073896 discloses a cartridge in which the underside of the cartridge is provided with perforations and is covered with a film, which film has to be removed before use. This cartridge also is suitable for a liquid concentrate (p. 14, lines 3-8, and Claim 18), hot water being conveyed through the concentrate from an inflow aperture on the upper side and the concentrate thereby being diluted to a beverage, and said beverage leaving the cartridge through the preformed perforations on the underside.

WO-A1-03/053200 and WO-A1-02/19875 disclose a cartridge made of a flexible material which are suitable, inter alia, for a liquid concentrate (WO-A1-03/053200, p. 5, lines 19-21; WO-A1-02/19875, p. 19, lines 4-6) for use in a hot water appliance, the cartridge being wedged in a cavity intended for said cartridge and being pierced with a hollow needle, after which the water is conveyed through the concentrate to the outflow aperture.

U.S. Pat. No. 6,130,990 discloses a hot water appliance which is suitable for preparing a beverage based on concentrate in a cartridge (col. 5, lines 54-67; col. 7, lines 58-61, col. 9, line 66-col. 10, line 6).

U.S. Pat. No. 4,886,674 discloses a cartridge made of a flexible material which is suitable, inter alia, for a liquid concentrate, the water supply being passed through the concentrate, by way of a connection point, to an outflow aperture which is created by a weakened sealing seam, which sealing seam is opened by the working pressure of the appliance.

European Patent Applications EP-A-1 440 907 and EP-A-1 440 908 disclose a cartridge for use in the preparation of beverages. Said cartridge is dome-shaped, which dome shape is closed by means of a film on the underside, and on the side with the film is provided with both an inlet aperture (on the edge) and an outlet aperture (in the centre). Water (hot water) is conveyed by way of a point shaped inflow aperture on the underside of the cartridge, by way of a ‘ring line’ containing distribution apertures, against the closing film, and further by way of said distribution apertures through a compartment. The compartment contains a concentrate, and the water dilutes the concentrate to a beverage by means of turbulence, which beverage is subsequently conveyed by way of a siphon to an outflow aperture on the underside of the cartridge. Special measures are also present in the cartridge to make the water from the inlet aperture flow proportionally, directed radially inwards, through the interior space of the cartridge.

In a further embodiment EP-A-1 440 907 discloses a method for controlling the mixing of the water with the concentrate by means of facilities with which the mixing of the concentrate with the water is retarded. This facility is in the form of a type of dish, and the concentrate is added in a retarded manner through the holes on the underside of the dish to the flow path of the water.

None of the cartridges discussed above can be used in a hot water appliance suitable for extraction pads made of filter material, so that it is necessary to use a preparation appliance suitable specifically for these respective cartridge types. In particular, the connection of the inflow point to the cartridges means that hot water appliances which are suitable for extraction pads made of filter material are unsuitable for the above-mentioned cartridges.

### SUMMARY OF THE INVENTION

The present invention aims to provide a cartridge or cup for a liquid concentrate and a holder which are suitable for the preparation of beverages making use of a conventionally used hot water appliance, for example a hot water appliance that is suitable for extraction pads made of filter material.

According to the present invention, a cup (also called a cartridge or reservoir) of the type defined in the preamble is provided, in which the covering layer is provided with liquid-permeable perforations and substantially the greater part of the surface of the covering layer serves as the inlet aperture for receiving a liquid suitable for the preparation substance. By this measure, said cup can be used in conventional hot water appliances designed for the portion-wise preparation of beverages. The possibility of feeding in liquid over a large surface also ensures that a good mixing result is obtained without complex measures being necessary in the cup itself.

In a further embodiment, on a side facing away from the cup-shaped dish element the covering layer is furthermore provided with a removable closing layer, for example in the form of a pull-off aluminium foil. This ensures that the product remains in the cup and that the product stays fresh. The closing layer can simply be removed before use.

In a further embodiment the outlet aperture is placed in a side of the cup-shaped dish element situated opposite the open side. Owing to the fact that the inlet aperture and outlet aperture are situated on opposite sides of the cup, the cup is suitable for use in the abovementioned conventional hot water appliances.

The cup-shaped dish element can furthermore be provided with a perforation space (substantially cylindrical), which is situated around the outlet aperture and extends to the interior space of the cup, the outlet aperture and perforation space being closable with a cut-through seal. When a cup for use in the holder is placed in the hot water appliance, this automatically results in the seal on the outlet side of the cup being broken, and the cup is ready for use.

In a further embodiment the cup-shaped element is furthermore provided with a cylindrical element, which is situated concentrically around the perforation space, an edge of the cylindrical element connecting to the cup-shaped dish element and being provided with at least one aperture, and an opposite edge thereof being connected to the covering layer. This produces a sort of labyrinth or meandering channel from the interior space of the cup, by way of the apertures, a first channel (between cylindrical element and a wall of the perforation space) and a second channel (bounded by another wall of the perforation space) to the outlet aperture, as a result of which good mixing of concentrate with liquid can occur.

In a further embodiment the at least one first aperture comprises at least one meandering channel at the level of the edge of the cylindrical element. A channel formed in this way can advantageously influence a venturi effect which occurs.

In a further embodiment the cup furthermore comprises a second wall parallel to and situated on the inside of the cylindrical element, an edge of the second wall connecting to the cup-shaped dish element and being provided with at least one aperture, and an opposite edge thereof also being connected to the covering layer. A first and a second chamber part are formed in this way, in which chamber parts, for example, two different preparation substances, or two of the same preparation substances, can be stored for the preparation of a hot beverage. Apertures are present, for example in the wall on the cup-shaped part side, for connection of the first chamber part and the second chamber part. Apertures can also be provided in the second wall in order to make connections between the second chamber part and the first channels. This produces a labyrinthine path for the liquid, with the result that good mixing of the liquid with the preparation substances occurs.

In yet a further embodiment the cup is shaped in such a way that the seal blocks the at least one first aperture and/or the at least one second aperture and opens them by pressure build-up. The preparation substances possibly present then cannot mix with each other during storage and transport of a filled cup. Owing to the pressure increase occurring during use, apertures are in fact produced, so that the above-described flow of liquid through the cup becomes possible.

In a further embodiment in a central part the covering layer is supported by additional supporting elements, in order to ensure that under pressure from the hot water appliance the covering layer does not close off the path to the outlet aperture of the cup.

For improvement of the mixing of concentrate with introduced liquid, in a further embodiment on the side facing the cup-shaped dish element the covering layer is provided with a segmented layer. The parts of the segmented layer are moved away from the covering layer under pressure from the liquid and, as it were, fall onto the concentrate in the cup, resulting in more gradual mixing.

In yet a further embodiment the cup-shaped dish element is provided with one or more first channels, which lie parallel to a longitudinal axis of the perforation space, and are designed to form a labyrinthine liquid connection between perforations of the perforated covering layer and the outlet aperture. The outside edges of the channels together with the walls forming the perforation space are connected to the covering layer, in order to form a labyrinthine path for the liquid in this way.

In one embodiment the first channels are formed by channels tapering outward in the direction of flow. By means of the tapering shape, the mixture of liquid and preparation substance calms down slightly before completing the last part of the labyrinthine path in which mixing by turbulence occurs again. More efficient mixing of liquid and preparation substance occurs through the alternating turbulent and calm parts in the labyrinthine path.

In a further embodiment the cup comprises one or more cutting elements, which are placed in the vicinity of the outlet aperture and extend into the perforation space. In the storage position the perforation space is closed by a seal, which in interaction with the holder, and in this embodiment with the cutting elements, is cut through and pushed away from the outlet aperture.

Because in this embodiment the cutting element is present on the cup, which is intended for a single use, the holder, which can be used a number of times, does not have to be provided with a cutting element. This means that the production of the holder can be simpler.

In a further embodiment the inside of the cup-shaped element comprises several walls, which sub-divide the interior space into two or more compartments. The compartments can contain the same preparation substance or different preparation substances.

In a further aspect the present invention relates to a holder for use with a cup according to the present invention, the holder being provided with a cup-shaped dish element which is substantially congruent with the cup-shaped dish element of the cup and is designed to receive the cup. Said holder can be placed in the hot water appliance in a space provided for the purpose.

In a further embodiment the cup-shaped dish element of the holder comprises a central aperture with a cylindrical edge, the cylindrical edge comprising a first edge part and a second edge part, the first edge part being sharper and extending further into the cup-shaped dish element than the second edge part. In this way the seal of the cup can be broken or cut through on the outlet side in a simple and reliable manner, after which the second edge part pushes the seal into the perforation space of the cup without cutting through it. In this way the outlet aperture of the cup is opened for use in a simple and reliable manner.

In an alternative embodiment the cup-shaped dish element comprises a central aperture with a straight cylindrical edge. This embodiment, in conjunction with an embodiment of the cup which is provided with one or more cutting elements, is capable of breaking the seal on the underside of the cup and pushing the residues away from the outlet aperture into the perforation space.

In yet a further aspect the present invention relates to the use of a holder and a cup according to the present invention in a hot water appliance provided with an accommodation space for accommodating the holder and cup, the hot water appliance being designed to convey heated water through the holder and cup by way of the perforated covering layer of the cup.

### BRIEF DESCRIPTION OF THE DRAWINGS

The present invention will now be discussed in more detail on the basis of a number of illustrative embodiments, with reference to the appended drawings, in which

FIG. 1 shows an inclined bottom view in perspective of a first embodiment of the cup according to the present invention;

FIG. 2 shows an inclined top view in perspective of the cup according to FIG. 1;

FIG. 3 shows a sectional view of the cup according to FIG. 1;

FIG. 4 shows a bottom view of the cup according to FIG. 1 without seal;

FIG. 5 shows a sectional view of a holder for use with the cup of FIG. 1;

FIGS. 6a to 6c show a sequence in section of the fitting of the cup of FIG. 1 in the holder of FIG. 5;

FIG. 7 shows a sectional view in perspective of a part of a cup according to a further embodiment;

FIG. 8 shows a sectional view in perspective of yet a further embodiment;

FIG. 9 shows a sectional view in perspective of a part of a cup according to a further embodiment;

FIG. 10 shows a perspective view of a cup according to yet a further embodiment;

FIG. 11 shows a top view in perspective of a cup according to yet a further embodiment;

FIG. 12 shows a bottom view in perspective of the cup according to the embodiment of FIG. 11;

FIG. 13 shows a perspective view with partial section of the cup according to the embodiment of FIG. 11;

FIG. 14 shows a side view with a partial section of the cup according to the embodiment of FIG. 11;

FIG. 15 shows a perspective view of a cup according to yet a further embodiment with several compartments;

FIG. 16 shows a side view in section of a holder according to a further embodiment;

FIG. 17a shows a perspective view with partial section of a cup according to a further embodiment;

FIG. 17b shows a bottom view of the cup 10 according to the embodiment of FIG. 17a, with the seal removed;

FIG. 18a shows a perspective view with partial section of a cup according to yet a further embodiment; and

FIG. 18b shows a bottom view of the cup 10 according to the embodiment of FIG. 18a.

### DETAILED DESCRIPTION OF ILLUSTRATIVE EMBODIMENTS

With the holder and cup according to the present invention it is possible to prepare hot drinks such as hot chocolate using a hot water appliance. For this purpose, the cup (also called a cartridge or reservoir) is filled with a concentrate, which is mixed with warm/hot water by means of the appliance and conveyed into a drinking cup or mug. It is also possible to prepare other beverages or dishes based on a concentrate or other preparation substance, milk products, fruit juices, sauces and desserts.

The preparation substance is a product which is soluble or suspendable in a liquid and can be in the form of a powder, a (concentrated) liquid, a syrup, a gel or in another similar form. If a powder is used, said powder preferably does not contain difficulty soluble or non-soluble substances (such as certain proteins), so that good mixing with hot water is ensured in the cup. It is possible, for example in the embodiment of the cup 10 with several compartments to be described later, to use combinations of preparation substances, even a combination of a concentrate and a powder.

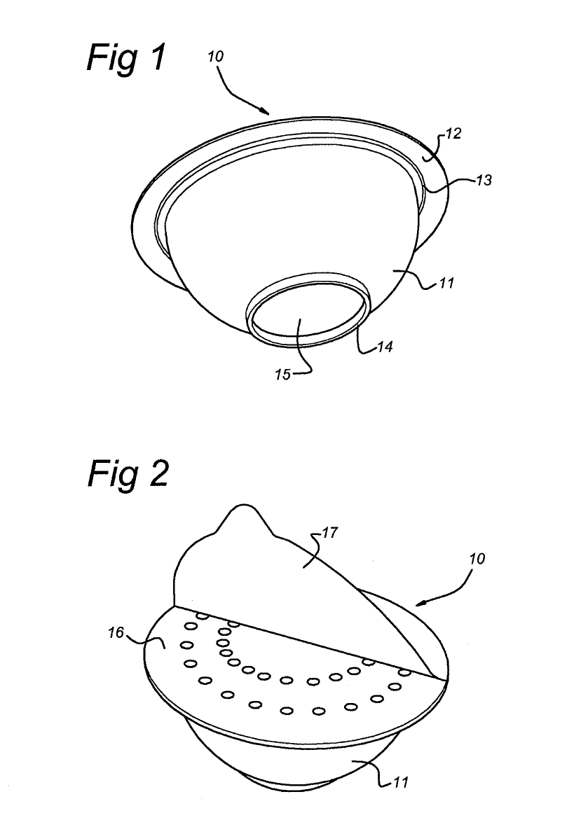

FIG. 1 shows a perspective view of an underside of a cup 10 according to an embodiment according to the present invention. The cup 10 has a cup-shaped underside 11 and an edge 12 on the upper side. The edge 12 is furthermore provided with a sealing edge 13, which in conjunction with a holder (see below) provides a seal of the assembly of holder and cup 10, so that water from the appliance is forced through the cup 10. The cup-shaped underside 11 is furthermore provided with an edge 14. The cup-shaped underside 11 is closed within the edge 14 by a seal 15 for transport and storage. The seal 15 is, for example, a plastic seal which is suitable for use in combination with foods.

A top view in perspective of the cup 10 of FIG. 1 is shown in FIG. 2. The cup 10 is closed on the upper side with a double seal, which comprises a perforated covering layer 16 and a pull-off layer 17. The perforated covering layer 16 is made of, for example, a suitable plastic (for example, polypropylene), and the pull-off layer 17 of another suitable material (for example an aluminium-based foil).

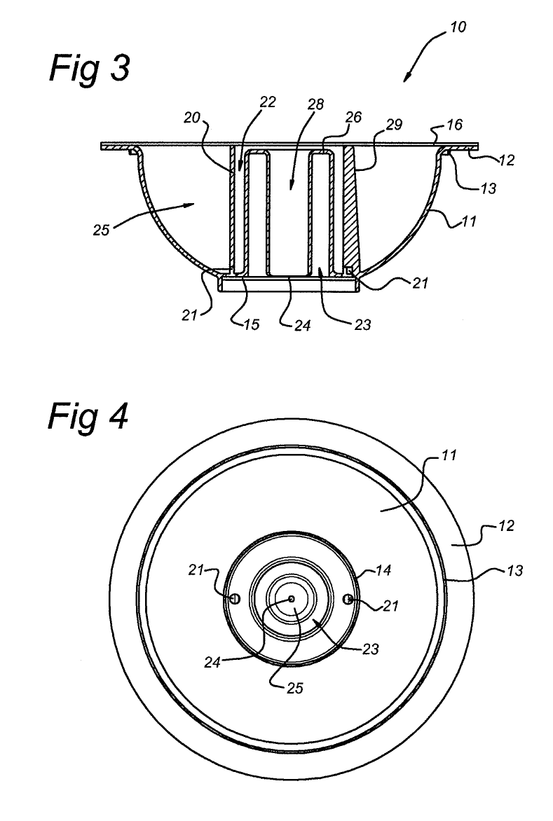

FIG. 3 shows a sectional view of the cup 10 according to the embodiment of FIGS. 1 and 2, illustrating the internal layout of the cup 10. The inside of the cup 10 comprises a chamber part 25, in which the concentrate can be placed. Interior parts, comprising a cylindrical element 20 and a central guide element 26, are placed on the inside of the cup 10. The cylindrical element 20 is positioned coaxially with the central guide element 26. The complete unit is circular symmetrical and can be manufactured in a known manner from plastic (for example by injection moulding). The cylindrical element 20 can be provided with tangentially projecting ribs 29, which give a certain rigidity. Furthermore, the width of the projecting ribs 29 is such that said ribs fit into the edge 14 of another cup 10, making the cups nestable, which has advantages in the production process of filled cups 10 (stock of nested cups 10 for filling with concentrate).

The cylindrical element 20 is of such a height that the upper side of the cylindrical element 20 is flush with the edge 12 and touches the perforated covering layer 16. The perforated covering layer 16 is fastened to the edge 12 and to the upper side of the cylindrical element 20, thereby producing two zones of the covering layer: a central part without perforations and an annular part with perforations.

The guide element 26 is formed in such a way that a cylindrical perforation space 23 is formed on the underside, which perforation space is in communication with the outside of the cup 10. The guide element 26 with the cylindrical element 20 forms a first channel 22. On the underside of the cylindrical element feed-through apertures 21 are present in the cup-shaped underside 11, which feed-through apertures connect the chamber part 25 to the first channel 22. In the embodiment shown the apertures 21 are produced in an injection-moulding process. As an alternative, the apertures 21 can be provided later by drilling holes from the outside of the cup 10. The cup 10 can be formed easily as a complete unit, and the size and height of the apertures 21 can be determined easily. The aperture to the outside is subsequently sealed by the seal 15. In the centre of the cup 10 the guide element 26 forms a second channel 28, which on the underside is provided with a central aperture 24 (or outlet aperture) and is in communication with the first channel 22. In this embodiment the central aperture 24 has a smaller cross section than any of the first apertures 21.

The central aperture 24 in the embodiment shown is in the form of a hole in a flat part of the guide element 26. It has been found that the shape of the aperture 24 and the thickness of the flat part have an influence on the preparation of the beverage. In particular, the thickness of the flat part influences the formation of froth in the product to be prepared. The thinner the flat part, the more compact and sturdy the froth layer is on the product being prepared by the hot water appliance.

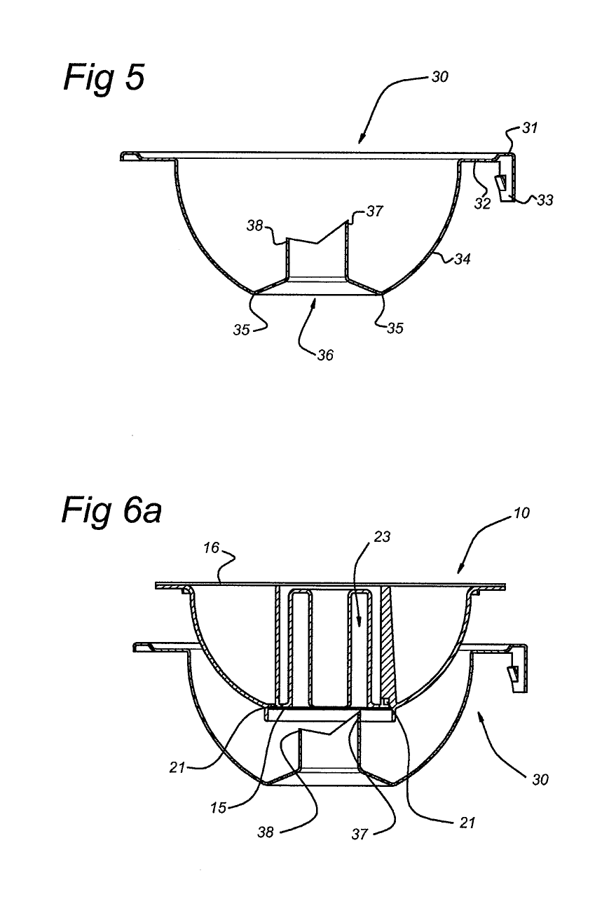

FIG. 5 shows a sectional view of a holder 30 which can be used together with a cup 10 in the hot water appliance. The holder 30 is provided with a cup-shaped dish element 34, which is substantially congruent with the cup-shaped underside 11 of the cup 10, and which can be placed in the hot water appliance instead of a conventional holder for coffee pads. The holder is provided on the upper side with a raised ring 31, against which a sealing element (rubber ring) of the hot water appliance rests during use. The holder 30 in this embodiment is furthermore provided with a lock 33 for fixing the holder 30 in the hot water appliance. Furthermore, the holder 30 is provided on the upper side with a second edge 32 which together with the edge 31 forms a recess in which the edge 12 of the cup 10 can be placed. The sealing edge 13 ensures that water supplied by the hot water appliance to the upper side of the assembly of holder 30 and cup 10 is in fact conveyed through the perforated covering layer 16 to the inside of the cup 10, and not around it. The holder 30 is removable from the hot water appliance again after use, after which it can be used again in the conventional manner for making a cup of coffee.

On the side of the holder 30 opposite the ring 31 the cup-shaped dish element 34 is provided with a central aperture 36 and one or more off-centre apertures 35 (for example, eight concentrically distributed apertures 35). The off-centre apertures 35 at the position of the central aperture 36 are situated as far as possible on the outside of the cup-shaped dish element 34, so that when the holder 30 is placed horizontally, the off-centre apertures 35 form the lowest point, and ultimately any liquid present in the holder 30 flows out through the off-centre apertures 35. The hot water appliance is designed to collect the prepared liquid from the aperture 36 (in fact the outlet aperture 24 in the cup 10) and the off-centre apertures 35 and convey it to a drinking cup or mug, for example by way of an outlet hose. The central aperture 36 comprises a cylindrical edge with a first edge part 37 and a second edge part 38. The first edge part 37 is a sharp edge which projects further inwards into the cup-shaped dish element 34 than the second edge part 38, which in this embodiment is not as sharp as the first edge part 37.

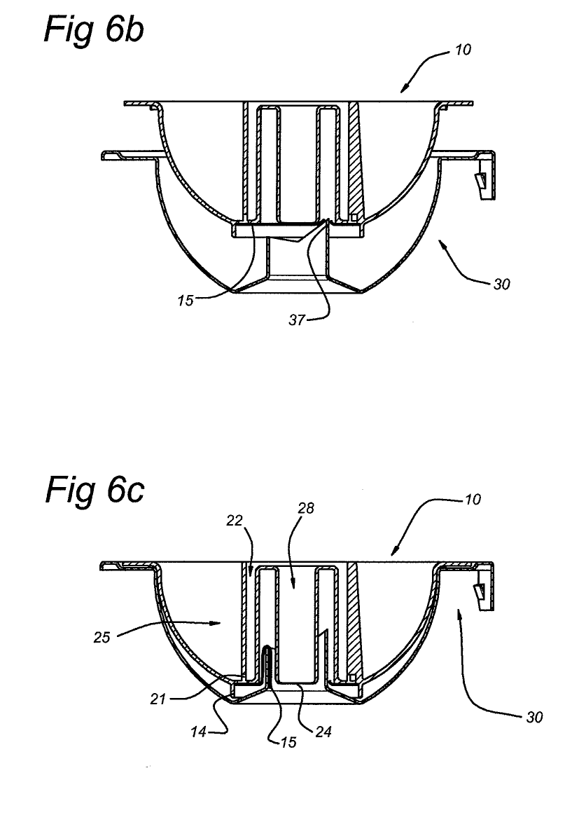

FIGS. 6a to 6c show how a cup 10 with concentrate is placed in a holder 30 (which is placed in the hot water appliance). The cup 10 at that stage only has the perforated covering layer 16; the pull-off layer 17 has already been removed. The seal 15 on the underside of the cup covers both the apertures 21, 24 and the perforation space 23 (FIG. 6a). FIG. 6b shows that the first edge part 37 of the holder 30 cuts through the seal 15 when the cup 10 is pressed down into the holder 30. As soon as the second edge part 38 touches the seal 15, it will not cut any further through the seal 15, but will push it into the perforation space 23, as shown in FIG. 6c. The shape of the perforation space 23 in combination with the shape of the first and second edge parts 37, 38 and the properties of the seal 15 ensure that the apertures 21 remain closed, while the central aperture 24 is in fact opened. The edge 14 of the cup 10 ultimately rests on the inside of the cup-shaped dish 34 of the holder 30. The whole unit is now ready to receive warm or hot liquid on the upper side of the cup 10.

In one embodiment the cup 10 has a cross section of approximately 73 mm, and in a further embodiment 67 mm, so that in combination with the holder 30 said cup can be used in a conventional hot water appliance of the type described above. Such a hot water appliance is provided with a sealing ring, which in the embodiment shown touches the outside edge 31 of the holder. Between the holder 30 and the cup 10 the sealing edge 13 provides a liquid-tight connection during use.

By adaptations of both the cup 10 and the holder 30 it is possible to increase the cross section of the cup 10, for example to 75 mm, in which case the sealing ring of the hot water appliance possibly makes direct contact with the cup 10. In this case more concentrate can be placed in the cup 10. As an alternative, the sealing edge 13 is part of the holder 30, and not of the cup 10.

It can be seen in FIG. 2 that the perforations in the perforated covering layer 16 are provided in a particular pattern. By changing the distribution of the perforations in the covering layer 16, a different flow pattern or flow ratio through the cup 10 can be achieved, which can lead to better mixing of the final product. The flow pattern or flow ratio can also be adapted to product properties, such as the viscosity. In general, the covering layer 16 can be divided into two areas, a central part which is bounded by the annular element 20, and an annular part which is situated outside it directly above the chamber part 25 of the cup 10. The central part is not provided with perforations, and owing to the fact that the covering layer 16 is fixed to the cylindrical element 20, no liquid can flow from the hot water appliance directly into the first channel 22 or the second channel 28. Liquid which penetrates through the perforated annular part comes into contact with the concentrate in the chamber part 25, will mix with said concentrate and will flow out through the central aperture 24 by way of one of the feed through apertures 21, the first channel 22 and the second channel 28. The whole combination of perforations, apertures 21, channels 22 and 28 and central aperture 24 gives a certain resistance to the liquid and also provides turbulence effects, with the result that the concentrate is mixed with the liquid. All the dimensions of the different parts of the cup 10 can be changed, so that the flow characteristics are influenced.

The perforations in the perforated covering layer 16 can be formed by round holes, as shown in the figures. In an alternative all of the perforations or, for example, only the perforations in a part of the perforated covering layer 16 can be of a different shape, for example elongated slits, transverse cuts etc.

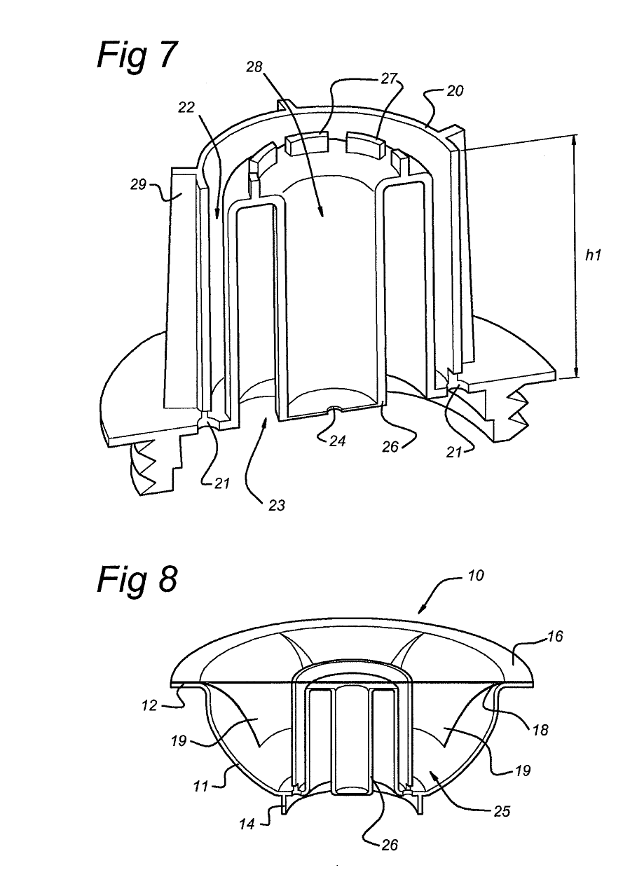

In a further illustrative embodiment, of which the interior part of the cup 10 is shown in perspective and in sectional view in FIG. 7, a number of additional supporting elements or barriers 27 are placed in a circular arrangement on top of the guide element 26, which supporting elements or barriers increase the resistance to the liquid with concentrate in the flow channel (first channel 22 and second channel 28) and cause additional turbulence in the liquid flow, so that the mixing result is improved even further. The barriers 27 also support the central part of the covering layer 16, so that the pressure from the hot water appliance does not cause the covering layer to close the second channel 28.

FIG. 7 also indicates the height h1 of the cylindrical element 20, which corresponds to the local height of the cup 10, so that the cylindrical element 20 connects with its edge 20a to the perforated covering layer 16, and a good seal is produced for the central part of the covering layer 16. In a further embodiment the height of the cylindrical element 20 and of the guide element 26 is approximately half the height h1. This, possibly in combination with a different distribution of the perforations in the perforated covering layer 16, produces a different flow pattern in the cup 10.

The flow pattern, and consequently the mixing behaviour of liquid with concentrate, can also be influenced in other ways in the cup 10. For instance, FIG. 8 shows in a sectional view in perspective an embodiment of the cup 10 in which a distribution layer 18 is provided between the perforated covering layer 16 and the remainder of the cup 10. In the embodiment shown the distribution layer 18 comprises a large number of flaps 19, which are fixed on the edge 12 of the cup 10. When liquid is forced through the perforated layer 16 the flaps 19 will bend back as far as the concentrate in the chamber part 25 and will cause additional turbulence in the chamber part, resulting in better mixing of liquid and concentrate.

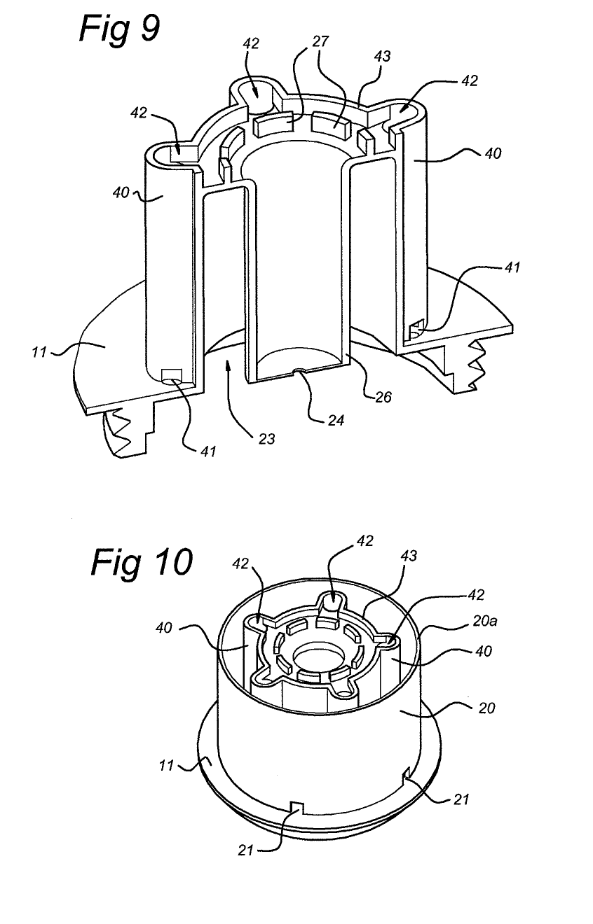

FIG. 9 shows a part of yet a further variant of the cup 10 in a sectional view in perspective. In contrast with the single first channel 22, which in the embodiments described above was formed by the cylindrical element 20 and the guide element 26, this embodiment is provided with a plurality of first channels 42, which are partly formed by walls 40 on the guide element 26 (the cylindrical element 20 is completely absent in this embodiment). The upper edges of the channels 42 with the extended wall of the guide element form an edge 43 with a flower-shaped pattern, on which the covering layer is immovably fixed. This again produces a central part (without perforations) and an annular part (with perforations) in the covering layer 16. Each channel 42 is provided with one or more appropriate apertures 41 on the side near the cup-shaped underside 11. Said apertures 41 can be provided in the same way as the apertures 21. Owing to the fact that the first channels 42 have a smaller cross section than the single first channel 22, a different flow pattern again is obtained.

Yet another flow pattern occurs when in the embodiment of FIG. 9 a cylindrical element 20 is also fitted, with a plurality of apertures 21, as shown in the perspective view of FIG. 10. In this embodiment the flow pattern can be influenced even further by varying the position of the apertures 21 relative to the position of the first channels 42. In this embodiment not only the flower-shaped edge 43 of the guide element 26, but also the top edge 20a of the cylindrical element 20 is fixed to the covering layer 16, so that next to the central part without perforations a first annular part with perforations (between edge 43 and the edge of cylindrical element 20) and a second annular part with perforations (between the edge of cylindrical element 20 and the edge 12) is formed. The perforation pattern of the perforated covering layer 16 is then, for example, selected in such a way that approximately 80% of the surface area of the apertures is situated in the first annular part, and approximately 20% is situated in the second annular part. A satisfactory mixing result is achieved in this way. By making a large part of the liquid flow through the first annular part, a sort of venturi effect is obtained, with the result that liquid with concentrate is drawn through the apertures 21. A good effect is obtained at ratios between 60:40 and 80:20, the best result being obtained between 66.7% and 75% of the surface area of the apertures in the first annular part.

In an alternative embodiment the covering layer 16 is perforated only at the position of the second chamber part 65 and the wall 20a is provided with notches or grooves (not shown). Said notches or grooves serve to prevent a vacuum forming in the second chamber part 65. This makes a fully controlled flow path in the cup 10 possible.

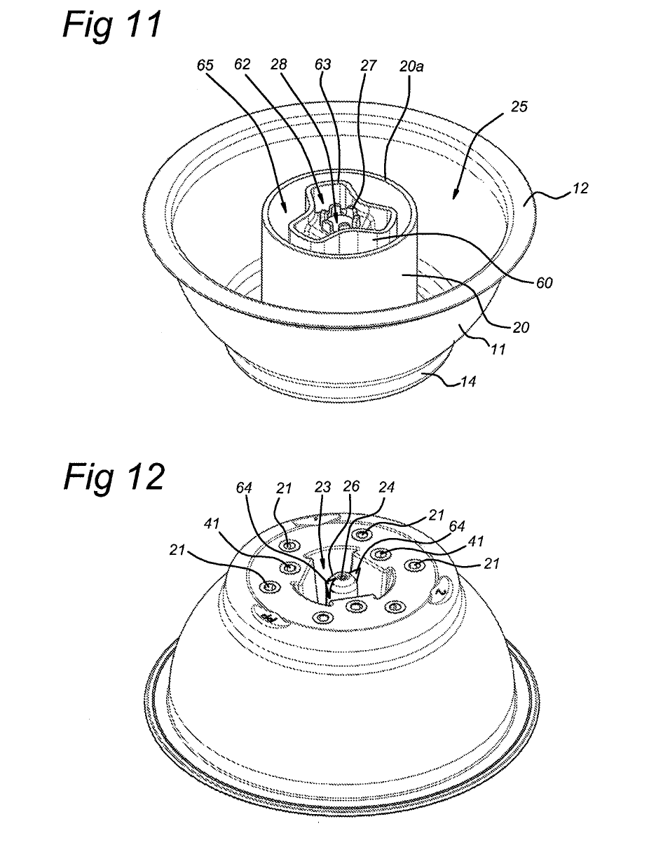

FIG. 11 shows yet a further embodiment of the cup 10 in a perspective view. The cup again comprises a cup-shaped underside 11 with edge 12 and edge 14 on the underside. The cup 10 is also provided with a chamber part 25 and a cylindrical element 20. A wall 60 is present inside the cylindrical element 20, so that a second chamber part 65 is formed next to the chamber part 25. The second channel 28 is present within the wall 60, which second channel on the underside of the cup 10 opens into the central aperture 24. Within the wall 60 three tapering channels 62 are also present, which will be described in more detail below. Just as in embodiments discussed earlier, a number of barriers 27 are present on the edge of the start of the second channel 28, which barriers are effective in mixing the flow of liquid containing the dilute concentrate. As shown in FIG. 11, the barriers 27 can be of a special shape with a sharp edge on the outside and a rounded edge on the inside. This reinforces the turbulence effect in the cup 10, and in this form can also be used in the embodiments discussed earlier.

FIG. 12 shows the underside of the cup 10 according to the embodiment of FIG. 11 in perspective view. Clearly visible are the apertures 21 provided at the level of the cylindrical element 20 and giving a connection between the chamber part 25 and second chamber part 65. The apertures 41 at the level of the walls 40 (in the embodiment of FIG. 10) or the walls 60 (in the embodiment of FIG. 11) are also visible. After filling of the cup 10 with concentrate the underside of the cup 10 is closed with a seal 15, so that the apertures 21 and 41 are closed.

In the first instance the perforation space 23 and central aperture 24 are therefore closed. In order to break this seal 15 before use, the holder shown in FIG. 5 can be used, or a variant which is shown in sectional view in FIG. 16 can be used. In this further embodiment the holder 30 is provided with a straight edge 39. Said straight edge 39 does not need to be sharp, so that there is no risk of injuries from use of the holder 30. The holder 30 can interact with a cup 10 according to the embodiment shown in FIG. 12, in which case the central guide element 26 is provided on the underside (i.e. near the outflow aperture 24) with two cutting elements 64. Through the interaction of straight edge 39 and the cutting elements 64, the covering film 15 on the underside of cup 10 will be cut through at exactly the desired point, and the parts of the sealing film 15 will be pressed into the perforation space 23, while the apertures 21, 41 will simply remain sealed. The embodiment of the cup 10 shown can still be produced by simple production methods, such as injection moulding with a simple mould. Of course, it is possible to provide a plurality of cutting elements 64, or cutting elements of a different shape. This embodiment furthermore has the advantage that the cutting elements 64 are part of the disposable cup 10. Wear of the cutting edges 37, 38 is consequently prevented. The cutting elements 64 can also be used in the other abovementioned embodiments of the cup 10.

The central aperture 24, or outflow aperture, is provided in a slightly recessed manner in the central guide element 26 in the embodiment shown, so that residues of a prepared beverage cannot fall into the holder 30 or hot water appliance.

The central guide element 26 can project slightly beyond the bottom of the cup 10 in which the apertures 21, 41 are provided. This means that the seal 15 is under slight tension, so that leakage of product from the cup 10 during storage or transport is largely prevented.

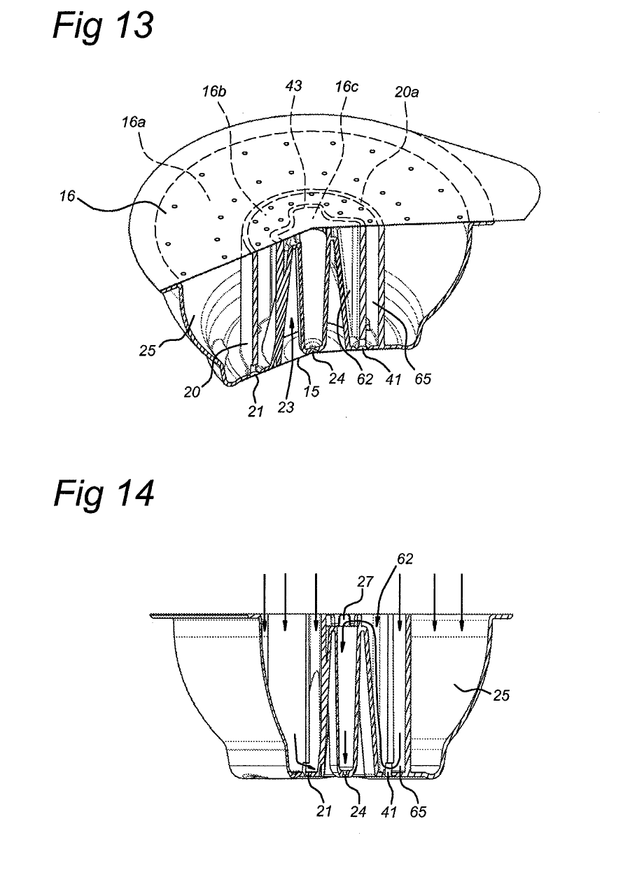

FIG. 13 shows a perspective view with a partial sectional view of the cup 10. On the upper side the perforated covering layer 16 is visible in the drawing, the dotted lines indicating where the underlying structures are present. Thus the covering film 16 is fixed not only on the edge 12, but also on the edge 20a of the cylindrical element 20 and the edge 63 of the wall 60. In this way the covering layer 16, as in the case of the embodiment of FIG. 10, is divided into three parts: a first annular part 16a with perforations, a second annular part 16b, likewise with perforations, and a central part 16c without perforations. The first annular part 16a lies above the chamber part 25 and the second annular part lies above the second chamber part 65. Compared with the embodiment of FIG. 10, the edge 63 has a smaller perimeter than the edge 43, so that there is less risk of the fastening of the covering layer 16 becoming detached, which could give rise to leakage of concentrate from the second chamber part 65.

It is clearly visible in the sectional view of FIG. 13 that the tapering channels 62 taper outward from the bottom to the top. Owing to the tapering shape, the mixture of water and concentrate flowing through the apertures 41 into the tapering channels is slowed down, after which the flow through the bend to the second channel 28 and the barriers 27 is made turbulent again for an optimum mixing result. In this embodiment three tapering channels 62 are present, but the number can vary and, for example, can be two.

In the cutaway side view of the embodiment in FIG. 14 the flow of liquid is indicated by arrows. From the upper side the hot water appliance forces liquid through the covering layer 16, i.e. through the two annular parts 16a and 16b, after which said liquid passes into the chamber part 25 and second chamber part 65, respectively. Concentrate, for example for drinking chocolate, is present in the two chamber parts 25, 65, which concentrate mixes with the hot water. From the chamber part 25 the mixture of water and concentrate is forced through the apertures 21 in the second chamber part 65. This is, however, counteracted by the mixture present in the second chamber part 65, which flows through apertures 41 to the tapering channels 62. At a particular point, however, all concentrate from the second chamber part 65 will be dissolved, after which the flow of hot water through the apertures 21 will carry the mixture along with it out of the chamber part 25 by a sort of venturi effect. On the upper side of the tapering channels 62 the mixture flows through the barriers 27, which cause extra turbulence and thus mixing, to the second channel 28 and from there out through the central aperture 24 and into a drinking cup.

The cup 10 according to the above embodiment has a single interior space or chamber part 25. For the preparation of some products in a hot water appliance various preparation substances are used for a single beverage/dish. The cup 10 can be adapted for this, by using a separate part (compartment) of the cup for each preparation substance. Each part then has its own chamber part 25, labyrinthine path (aperture(s) 21, first channel 22, second channel 28), and outlet aperture 24. In this way it is possible to place a basic concentrate in a large compartment and an added flavouring in a small compartment, so that in the production process there can be differentiation according to flavour, while the same basic concentrate can be used for all flavours. The geometry of the cup 10 is determined in such a way that the two compartments flow out uniformly through two separate outlet apertures 24. By directing the outflow of liquid relative to the outlet aperture of the hot water appliance, the two different parts of the beverage can, if necessary, largely be prevented from mixing with each other.

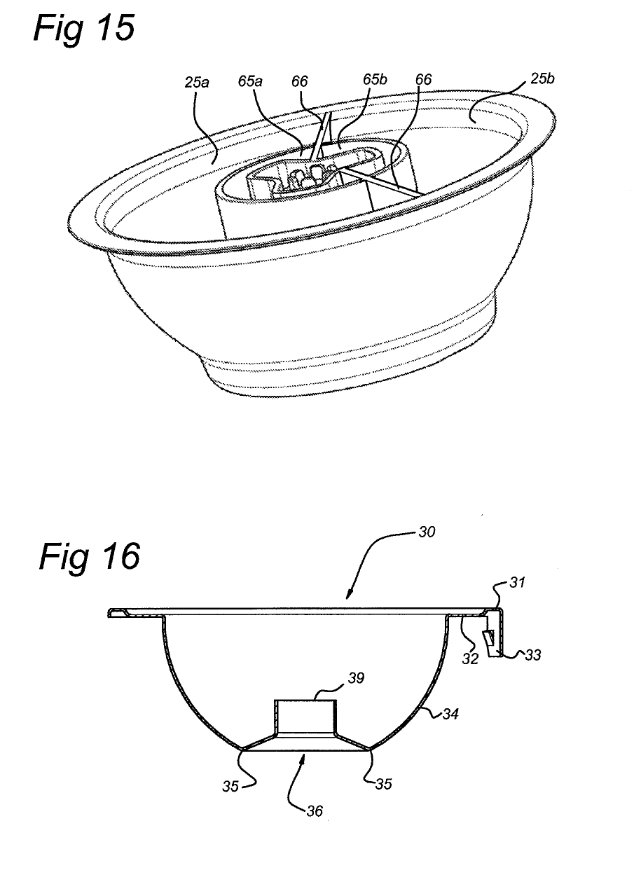

FIG. 15 shows yet a further embodiment of the cup 10. In this case the chamber part 25 is split into two unequal parts or compartments 25a and 25b, and the second chamber part 65 is split into two parts or compartments 65a and 65b by means of walls 66. The division is chosen to be the same as the division of the tapering channels 62, so that, for example, it is possible to use two different preparation substances which come together only at the upper side of the second channel 28, after they have been mixed well with the liquid by the turbulent flow through apertures 41 and 21. The mixed product is then discharged through the single outlet aperture 24. A division into three compartments can be made in a similar way in the embodiment of FIG. 11.

The different compartments can again be filled with different preparation substances, but it is also possible to fill several compartments with the same preparation substance.

In a known hot water appliance the hot water will penetrate into the cup 10, i.e. into the perforated parts 16a, 16b present, spread over the entire covering layer 16. This means that in the embodiments with compartments 25a, 25b, 65a, 65b mixing with the preparation substances present will occur virtually simultaneously. In many applications, for example chocolate concentrate with a flavouring concentrate, this is actually what is desired. However, in some cases two preparation substances are required to be mixed substantially one after the other and discharged through the outlet aperture 24. This is possible, for example, by, during production, closing off the tapering channel 62 for the substance to be mixed later, using a virtually tasteless and odourless wax product, which melts slowly through the supply of hot water.

As an alternative, it is possible to adapt the hot water appliance in such a way that a certain part of the perforations in the covering layer 16 is provided with a hot water supply at a different time from that of an other part (for example, corresponding to the division into compartments 25a, 65a, 25b, 65b).

In one embodiment the cup 10 is filled with two preparation substances, for example a coloured and/or flavoured concentrate and a milk concentrate. In the embodiment shown in FIG. 11, for example, the chamber part 25 is filled with the milk concentrate, and the second chamber part 65 is filled with the coloured and/or flavoured concentrate. Through the distribution of the holes in the first and second annular parts 16a, 16b of the perforated covering layer 16, the water from the hot water appliance seeks the easiest route. This means that the preparation substance (coloured and/or flavoured concentrate) is first forced out of the second chamber part 65, and only then is the preparation substance (milk concentrate) forced out of the chamber part 25. The result is a two-layer beverage perfectly prepared with the hot water appliance, the preparation also being visually attractive: the coloured beverage first flows out of the appliance, after which the flow becomes white and the hot water appliance serves up an attractive white milky froth layer. In order to prevent the two preparation substances from mixing in the cup (after production), the specific gravity and viscosity of the two preparation substances are selected to be substantially equal.

In the embodiment of the cup 10 shown in FIG. 3 it is also possible to accommodate two preparation substances, a first chamber part 25 being formed by the boundary of dish-shaped element 11, cylindrical element 20 and covering layer 16, and a second chamber part being formed by the first channel 22 (adjoining the other side of cylindrical element 20 and covering layer 16). In the embodiment of the cup 10 shown in FIG. 10 it is also possible to accommodate two preparation substances in the cup 10: a first preparation substance in a first chamber part 25 which is bounded by dish-shaped element 11, covering layer 16 and cylindrical element 20, and a second preparation substance in a second chamber part which is bounded by cylindrical element 20, dish-shaped element 11, covering layer 16 and walls 40.

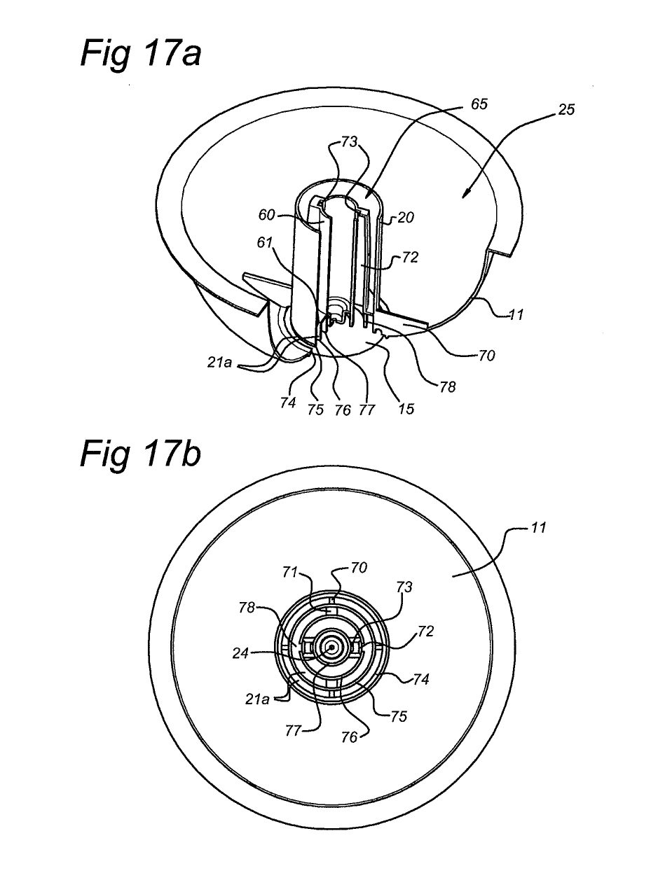

If a cup 10 with two chamber parts 25, 65 is used, the substances in those chamber parts 25, 65 may possibly mix slightly through the apertures 21. In order to prevent this, the alternative embodiment shown in the views with partial section in FIG. 17a and the bottom view in FIG. 17b (in which for the sake of clarity the seal 15 is omitted) can be used. Instead of the aperture 21 in the cup-shaped underside 11 at the level of the cylindrical element 20 (see, for example, the embodiment of FIG. 13), which extends on into a part of the cylindrical element 20, in this embodiment two partial apertures 21a are provided on either side of a bottom edge 75 of the cylindrical element 20. In the embodiment shown two outflow channels 72 are present, being placed diametrically opposite each other in the second chamber part 65. Two ribs 70 are formed on the cylindrical element 20, so that the entire interior parts of the cup 10 are fixed on the cup-shaped underside 11. At the level of the outflow channels 72 and the wall 60 respective edges 76 and 77 are present. The seal 15 is fixed sturdily (for example, by means of gluing or sealing techniques) on an edge 74 of the cup-shaped underside 11, and on the edges 76 and 77, and is detachably fixed to the edge 75. In this way mixing of preparation substance in the first chamber part 25 and preparation substance in the second chamber part 65 during transport and storage of filled cups 10 is effectively prevented. During use of the cup 10 in a hot water appliance under the influence of the pressure built up in the first chamber part 25 the seal 15 will then come away from the edge 75 of the cylindrical element 20, so that a throughflow aperture is still produced from the first chamber part 25 to the second chamber part 65 through the apertures 21a, the edge 75 and the seal 15. An aperture 61 is made in the wall between second chamber part 65 and the space between edge 75 and edge 76. Apertures 78 are made in the edge 76 at the level of the outflow channels 72. During use liquid will flow through the first chamber part 25, mixing with the preparation substance present there, through the apertures 21a and the apertures 78, and through the two outflow channels 72 and the apertures 73 present on the upper side of said outflow channels to the outflow aperture 24. Liquid will also flow through the second chamber part 65, mixing with the preparation substance present there, through the apertures 61 and the apertures 78, and through the two outflow channels 72 and the apertures 73 present on the upper side of said outflow channels to the outflow aperture 24.

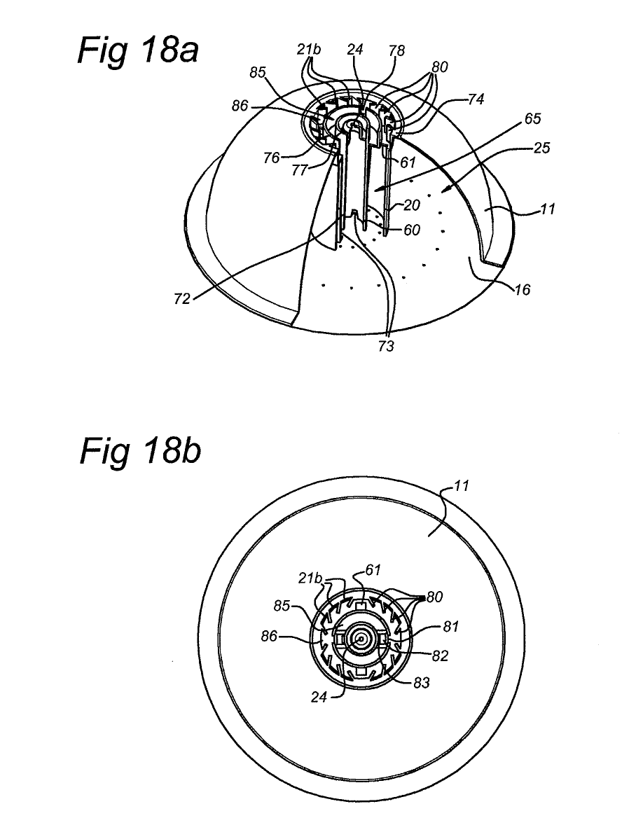

FIG. 18a shows a partial sectional view of yet a further embodiment, in which an improved venturi effect occurs to carry along the mixture of liquid and preparation substance out of the first chamber part 25. FIG. 18b shows the bottom view of the cup 10 according to this embodiment, in which just as in FIG. 18a the seal 15 is omitted. A number of elements of this embodiment are designed in the same way as those in the embodiment described with reference to FIGS. 17a and 17b, and are provided with the same reference numerals. Instead of the normal apertures 21 (see, for example, the embodiment of FIG. 13), meandering channels 21b are present, which channels influence the flow of the solution in the cup 10. On the underside of the cup 10, just as in the embodiment of FIGS. 17a and 17b, a first annular space 85 (between edges 76 and 77) and a second annular space 86 (between edges 74 and 76) are formed. The meandering channels 21b are formed by apertures in the bottom part of the cylindrical element 20 (or the edge 74) and a number of partitions 80. The partitions 80 are substantially directed towards the apertures 78 between the first and second annular spaces 85, 86. A better venturi effect can be achieved in this way, so that the preparation substance in the first chamber part 25 is carried along even more efficiently, and a stronger turbulence is also caused, so that better mixing with the second preparation substance is produced in the second chamber part 65. The flow of liquid is furthermore virtually the same as that in the embodiment shown in FIGS. 17a and 17b.

1. Cup for preparing a beverage by means of a hot water appliance, comprising a cup-shaped dish element (11) for holding a preparation substance, said cup-shaped dish element having an inlet aperture and an outlet aperture (24), the cup-shaped dish element (11) on an open side being provided with a covering layer (16), so that an interior space (25) of the cup (10) is formed for holding the preparation substance, wherein the covering layer (16) is provided with liquid-permeable perforations and substantially the greater part of the surface of the covering layer (16) serves as the inlet aperture for receiving a liquid suitable for the preparation substance, wherein the cup-shaped element (11) is furthermore provided with a cylindrical element (20), which is situated concentrically to a guide element (26) in the cup-shaped element (11), an edge of the cylindrical element (20) connecting to the cup-shaped dish element (11) and being provided with at least one first aperture (21), and an opposite edge (20a) thereof being connected to the covering layer (16).

2. Cup according to claim 1, wherein on a side facing away from the cup-shaped dish element (11) the covering layer (16) is furthermore provided with a removable closing layer (17).

3. Cup according to claim 1, wherein the outlet aperture (24) is placed in a side of the cup-shaped dish element (11) situated opposite the open side.

4. Cup according to claim 1, wherein the cup-shaped dish element (11) is furthermore provided with a perforation space (23), which is situated around the outlet aperture (24) and extends to the interior space of the cup (10), the outlet aperture (24) and perforation space (23) being closable with a cut-through seal (15).

5. Cup according to claim 4, wherein the cup (10) furthermore comprises one or more cutting elements (64), which are placed in the vicinity of the outlet aperture (24) and extend into the perforation space (23).

6. Cup according to claim 1, wherein the at least one first aperture (21) comprises at least one meandering channel (21b) at the level of the edge of the cylindrical element (20).

7. Cup according to claim 1, wherein a first chamber part (25) is formed between the cup-shaped dish element (11), cylindrical element (20) and covering layer (16), and a second chamber part (22; 65) is formed adjoining the other side of the cylindrical element (20) and the covering layer (16), and wherein the first chamber part (25) comprises a first preparation substance and the second chamber part (65) comprises a second preparation substance.

8. Cup according to claim 1, wherein the cup (10) furthermore comprises a second wall (40; 60) parallel to and situated on the inside of cylindrical element (20), an edge of the second wall (40; 60) connecting to the cup-shaped dish element (11) and being provided with at least one second aperture (41), and an opposite edge (43; 63) thereof also being connected to the covering layer (16).

9. Cup according to claim 1, wherein the seal (15) blocks the at least one first aperture (21; 21a) and/or the at least one second aperture (41) and opens them by pressure build-up.

10. Cup according to claim 1, wherein in a central part the covering layer (16) is supported by additional supporting elements (27).

11. Cup according to claim 1, wherein on the side facing the cup-shaped dish element (11) the covering layer (16) is provided with a segmented layer (18, 19).

12. Cup according to claim 1, wherein the cup-shaped dish element (11) is provided with one or more first channels (42; 62), which lie parallel to a longitudinal axis of the guide element (26), and are designed to form a labyrinthine liquid connection between perforations of the perforated covering layer (16) and the outlet aperture (24).

13. Cup according to claim 12, wherein the first channels are formed by channels (62) tapering outward in the direction of flow.

14. Cup according to claim 1, wherein the inside of the cup-shaped element (11) comprises several walls (66), which sub-divide the interior space (25) into two or more compartments (25a, 25b; 65a, 65b).
